(19) United States
(12) Patent Application Publication
(10) Pub. No.: US 2017/0050615 A1
(43) Pub. Date: Feb. 23, 2017

(54) MOBILE DEVICE FOR A KEYLESS ACCESS OR ACTUATION SYSTEM FOR MOTOR VEHICLES

(71) Applicant: HUF HÜLSBECK & FÜRST GMBH & CO. KG, Velbert (DE)

(72) Inventor: Mirko Schindler, Velbert (DE)

(73) Assignee: Huf Huelsbeck & Fuerst GmbH & Co. KG, Velbert (DE)

(21) Appl. No.: 15/118,744

(22) PCT Filed: Dec. 19, 2014
(86) PCT No.: PCT/EP2014/078679

§ 371 Date: Oct. 10, 2016

(30) Foreign Application Priority Data
Jan. 29, 2014 (DE) 10 2014 101 086.8

(51) Int. Cl. B60R 25/24; G07C 9/00

(52) U.S. Cl. CPC B60R 25/24; G07C 9/00309; B60R 2325/205; B60R 2325/101

(57) ABSTRACT

A mobile communication device which is designed for communication via a public communication network includes an interface for short range high frequency communication. The mobile communication device has an LF coil assembly with at least three receiving coils for low frequency signals. The LF receiving coils are each oriented in different spatial directions. The LF coil assembly is coupled to a control unit in the mobile communication device, such that the interface for high frequency communication can be activated by a signal received via the LF coil assembly.

The invention relates to a mobile communication device, e.g. a mobile telephone or a tablet-computer, which is used with a keyless access system for a vehicle.

Keyless access and start-up systems (keyless-entry, keyless-go) for vehicles are known in the prior art. Systems of this type allow access to vehicle functions, e.g. the opening of a door, in the event that the user carries an identification means (ID transmitter). This occurs without the user having to actively initiate an authorization dialog. The vehicle key or ID transmitter can be equipped for this with prefabricated components, e.g. so-called front ends for low frequency communication, e.g. components ready for use from the company NXP Semiconductors N.V.

The known keyless entry systems function such that when a user is in the proximity of a vehicle, a low frequency (LF) dialog is initiated on the part of the vehicle and an antenna attached thereto, with the vehicle key carried by the user. First, the vehicle emits a low frequency wake-up signal, which is received by the key, resulting in a high frequency authorization communication between the key and the vehicle. An LF signal in this context lies in the range of a few kilohertz to a few hundred kilohertz, e.g. 125 kHz.

A three dimensional low frequency antenna (3D-LF) and a high frequency antenna (HF) are carried on the key. The 3D-LF antenna has numerous coils oriented in different spatial directions, e.g. along the X, Y, and Z axes of a Cartesian coordinate system in three dimensional space.

A construction of this type is disclosed, for example, in EP 2 429 033, where the LF coil assembly is described in a suitable manner.

Furthermore, it is known in the prior art to couple mobile communication devices, which offer additional functions to the user, independently of the vehicle, to a vehicle. By way of example, the coupling of cellular telephones via radio signals with a limited range (e.g. Bluetooth) to motor vehicles is known, wherein functions of the vehicle are combined with functions of the mobile device. It is likewise known, to execute the access authorization to a vehicle with cellular telephones.

The object of the invention is to further improve the access to vehicles using multifunctional mobile devices, and to design these in a secure manner.

This object is achieved by the device having the features of Claim 1.

According to the invention, it is provided that a mobile device, in the form of a cellular telephone or a portable mobile computer, is equipped with an additional antenna assembly.

For this, a three dimensional antenna assembly is allocated to the mobile device, e.g. a 3D-LF front end, as is disclosed in EP 2 429 033, specified above.

This supplementation of hardware components of a mobile device expands the application possibilities of the mobile device for controlling access. Another, likewise applicable example of a three dimensional low frequency antenna assembly can also be found in WO 2005/088560.

The introduction of a 3D low frequency antenna assembly of this type enables the awakening of the cellular telephone with a wake-up signal transmitted from the vehicle. Furthermore, it is also possible for the vehicle to precisely locate the mobile device having the 3D-LF front end disposed therein. The locating with an antenna package of this type is known in the prior art. In order to trigger the respective desired and/or permissible keyless functionality, it is necessary for the locking system to be able to awaken the key, as well as determine the respective location of the key. With keyless systems of the type currently known, the awakening is carried out by emitting a magnetic wake-up field via low frequency LF antennas on the vehicle. Furthermore, a substantial quality feature is the precise delimitation between the interior and exterior of the vehicle. Numerous antennas are used for establishing the dimensions of this delimitation, which are successively activated in order to locate the position of the electronic key.

As a result of the different orientations of the antenna coils in a 3D-LF assembly, a locating signal is registered by the different coils in different strengths, depending on the location and position of the mobile device. By means of this short-range location detection, a check can be executed, for example, to see which vehicle door is closest to the user, and whether this can be unlocked, or whether a user is already inside the vehicle, and is authorized to start up the motor.

The supplementation of the mobile device with a 3D-LF front end allows for the complete functional assumption of a functionality disposed until now in the vehicle key in a mobile communication device. The authorization dialog provided in keyless-entry or keyless-go processes can occur via communication means already present in the mobile device for high frequency communication. In this context, high frequency means a frequency range higher than 10 MHz (e.g. NFC interfaces), in particular higher than 1 GHz. By way of example, initially, a determination of the position can occur using the 3D-LF front end. The actual authorization occurs via Bluetooth short-range communication between the vehicle and the mobile device, in order to transact the authorization dialog. The substantial advantage over prior concepts for access to a vehicle with a mobile device comprises an additional hardware component in the mobile device, which facilitates a reliable position location in the immediate vicinity to the vehicle, and increases the security of the overall access system.

On the other hand, the system offers significant advantages in terms of comfort over concepts in which the mobile device must be brought into the immediate vicinity of a vehicle component, in order to execute an authorization for example, e.g. via NFC communication.

The user can carry the mobile device, e.g. in a pocket, with the device according to the invention, and the communication dialog between the mobile device and the vehicle occurs in the same manner as with prior keyless-entry systems, without however, requiring that the additional vehicle key be carried as well.

In a further development of the invention, the 3D-LF coil assembly is formed in a module for expanding existing mobile devices. In this manner, mobile devices can be expanded to include the inventive function. The 3D-LF module can be connected to the device, e.g. via a plug-in interface present on the mobile device, and can exchange data with this device. With this embodiment, the function can then be removed by unplugging the module, e.g. in order to use the mobile device without the possibility of access to the vehicle, or to lend it out, for example.

The invention shall now be explained in greater detail based on the attached Figures.

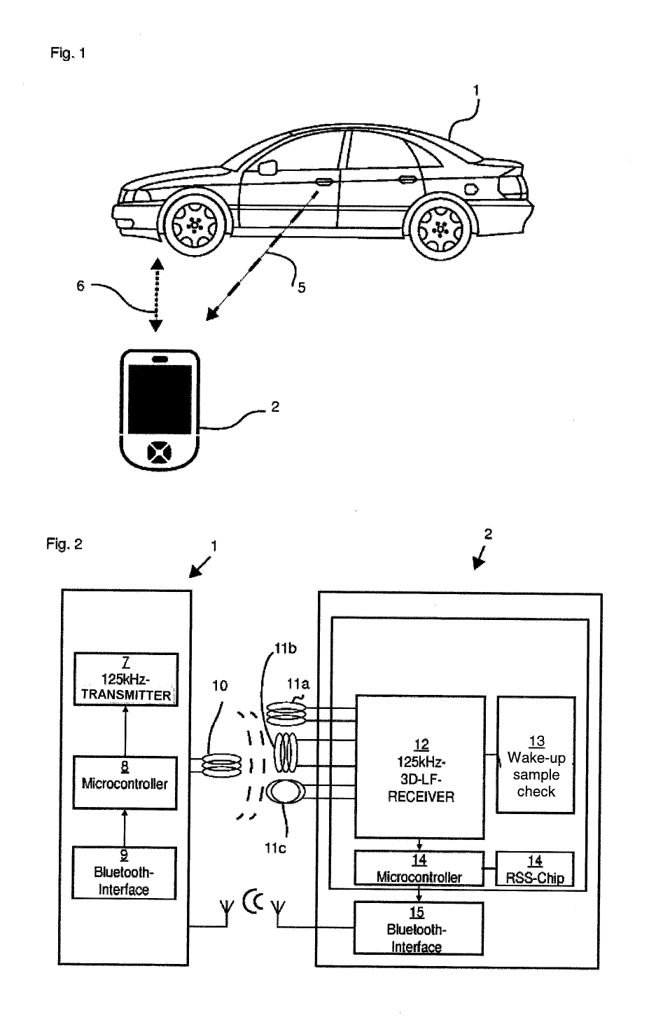

FIG. 1 shows, in a schematic manner, the signal paths between the vehicle and the cellular telephone in accordance with an exemplary embodiment of the invention;

FIG. 2 shows, in a schematic manner, the functional components of an embodiment of the invention.

A vehicle 1 is depicted in FIG. 1, which is approached by a user with a cellular telephone 2, in order to obtain access to the vehicle. The mobile telephone 2 has a 3D-LF coil assembly, which shall be explained below. When the user approaches the vehicle 1, e.g. when the hand of the user is moved into the proximity of the door handle of the driver door, transmission of a wake-up signal in the low frequency range (LF) is triggered in the vehicle. This wake-up signal is indicated by the arrow 5 here. The wake-up signal is emitted by one or more LF transmission coils in the vehicle.

The LF signal 5 is received by the cellular telephone 2, wherein the LF coils oriented in different spatial directions each receive different signal strengths, depending on their position in space in relation to the emitted signal 5. Because they are disposed, however, in a 3D arrangement, thus at right angles to one another in all three spatial directions, are at least at angles to one another, it is possible to receive the LF signal from the device 2 in any position, as long as the cellular telephone 2 is located within the transmission range of the signal 5, which is normally the case at most a few meters surrounding the vehicle.

Means for measuring the field strength of the received LF signal are disposed in the cellular telephone 2 with the antenna assembly. For this, an RSS chip (Radio Signal Strength chip) for example, is coupled to the LF coils. A chip of this type can a generate a signal strength indicator (RSSI) form the received LF signal, e.g. the RSSI signal can be depicted with a logarithmic relationship to the field strength of the LF signal. The RSSI signal then enables the determination of the location of the mobile telephone in relation to the vehicle.

An authorization mode is triggered in the cellular telephone by the wake-up signal 5, in which the cellular telephone enters into a dialog with the vehicle 1 via another radio interface, e.g. a Bluetooth connection. This radio dialog with a higher frequency is indicated by the arrow 6 here. Currently manufactured vehicles normally already have a Bluetooth interface. The RSSI data can be sent via the Bluetooth connection to the vehicle, which then executes a check, to see whether the position of the cellular telephone actually justifies an authorization. Furthermore, authorization data stored in the vehicle and cellular telephone can be checked and exchanged, in order to check the identification of the cellular telephone 2 for accessing the vehicle 1. An authorization dialog of this type normally requires the vehicle to learn the identity of the telephone, as is known in the prior art. In doing so, the mobile device 2 is introduced to the vehicle as a legitimate access means, and stored therein—however, such a procedure, also referred to as pairing, is known.

A substantial inventive element in this context, however, is the processing of the LF signals directly in the telephone 2 by an appropriate coil assembly, which significantly increases the security of the access control.

The LF signal transmission and thus the position determination that is executed, has been proven in the past to be an extremely reliable security feature for accessing a vehicle. By equipping the cellular telephone with such a coil assembly, whether this is in the telephone itself, or by means of a module that can be coupled thereto, the access security can be significantly increased.

In FIG. 2, the functional components of both the vehicle 1 as well as the cellular telephone 2 are depicted, to the extent that they are relevant to the device according to the invention. The vehicle 1 has an LF transmitter 7, a 125 kHz transmitter in this example, which is coupled to a microcontroller 8. A Bluetooth interface 9 is likewise coupled to the microcontroller 8, in order to execute a high frequency authorization dialog with the cellular telephone 2.

While the vehicle-side assembly has at least one LF transmission coil 10, the cellular telephone 2 receives with its 3D-LF front end via receiving coils 11a, 11b, 11c oriented in three spatial directions. These are coupled to a receiver unit 12 for the 125 kHz range, to which in turn, a device 13 for detecting the wake-up signal is coupled. This device 13 is to be operated in an extremely energy-efficient manner, analogous to the already known identifiers, and moreover, awakens the cellular telephone with its additional components only when an appropriate wake-up signal from the vehicle 1 has actually been received via the LF radio path.

A microcontroller 14 is coupled to the 125 kHz receiver 12, wherein the microcontroller 14 can also execute a signal strength evaluation with the chip device 14. The microcontroller 14 wakes up the Bluetooth interface 15 disposed in the cellular telephone 2 when it detects an LF wake-up signal, and initiates an authorization dialog with the Bluetooth interface 9 in the vehicle 1.

It is clear that the typical functionality of a cellular telephone 2 in accordance with the invention is improved by an appropriate receiving antenna assembly, together with an appropriate receiver. The security of a procedure for accessing the vehicle with a cellular telephone equipped in this manner is significantly higher than with authorization using only a Bluetooth interface, because an additional signal path and the accurate position determination of the mobile device can be used as accessing means.

1. A mobile communication device, which is designed for communication via a public communication network, including an interface for short-range high frequency communication, wherein the mobile communication device comprises a low frequency (LF) coil assembly with at least three receiving coils for low frequency (LF) signals, wherein the at least three LF receiving coils are each oriented in different spatial directions, wherein the LF coil assembly is coupled to a control unit in the mobile communication device, such that the interface for high frequency communication can be activated by a signal received via the LF coil assembly.

2. The mobile communication device according to claim 1, wherein the LF coil assembly is coupled to the control unit for determining a signal strength of the received LF signals.

3. The mobile communication device according to claim 1, wherein the interface for high frequency communication is designed as a Bluetooth interface or as an NFC interface.

4. The mobile communication device according to claim 1, wherein the LF coil assembly is designed as a component of a module, which is coupled to a mobile communication device via a standard interface.

5. The mobile communication device according to claim 4, wherein the module is coupled to the communication device via a plug-in connection for data transmission.

6. The mobile communication device according to claim 1, wherein the LF coil assembly is designed for receiving signals at a frequency of 125 kHz.
